(19) United States
(12) Patent Application Publication
(10) Pub. No.: US 2014/0114757 A1
(43) Pub. Date: Apr. 24, 2014

(54) Methods and Apparatus for Consumer Habit Tracking and Advertisement Provision

(71) Applicants: Scott Frankel, Los Angeles, CA (US); Greg Lam, Los Angeles, CA (US)

(72) Inventors: Scott Frankel, Los Angeles, CA (US); Greg Lam, Los Angeles, CA (US)

(21) Appl. No.: 14/045,036

(22) Filed: Oct. 3, 2013

Related U.S. Application Data
(60) Provisional application No. 61/715,963, filed on Oct. 19, 2012.

(51) Int. Cl. G06Q 30/02

(52) U.S. Cl. CPC G06Q 30/0255
USPC 705/14.53

(57) ABSTRACT

A system includes a processor configured to receive a request from a website, including a user identifier. The processor is also configured to receive information about one or more types of advertisements suitable for playback on the requesting website. Further, the processor is configured to identify a user record in a user database, based on the user identifier. Additionally, the processor is configured to determine one or more advertisements that are likely to appeal to the user and are suitable for playback on the requesting website. The processor is also configured to provide an advertisement recommendation to the requesting website.

### CROSS-REFERENCE TO RELATED APPLICATIONS

This application claims the benefit of U.S. provisional application Ser. No. 61/715,963 filed Oct. 19, 2012, the disclosure of which is hereby incorporated in its entirety by reference herein.

### TECHNICAL FIELD

The illustrative embodiments generally relates to methods and apparatuses for consumer habit tracking and advertisement provision.

### BACKGROUND

One of the great challenges facing content providers of many sites on the Internet is the ability to effectively monetize traffic in an attempt to utilize sites to generate revenue. While the Internet is populated by thousands and thousands of “free” websites, and many of these websites have desirable content, the virtually limitless range of potential competitors often incentivizes the content providers that run these sites to do everything in their power to keep usage of the site at a zero cost.

While a user-desired product and a “free” status can often serve to generate traffic and keep people interested, a constant and often increasing volume of users can generate its own set of problems for a site. Increased staffing and server utilization means increased cost, and often times site providers will turn to advertising (much in the same way that “free” network television does) as a viable stream of revenue.

Unfortunately, given the great degree of sites and the model that, unlike television, allows users to virtually ignore uninteresting advertisements, advertisers are often willing to pay far less for use of space on a virtual billboard on a site. Instead, the advertisers commonly prefer to pay on a “click” or “use” basis for the advertisements, thus ensuring at least some degree of bang for their buck.

While this has become at least one commonly utilized model, it then presents the problem of targeting advertisements to a particular user, in an effort to encourage clicking on the ad, if not an actual purchase of a product advertised thereby.

Due to the potentially lucrative returns from effective, targeted advertising, content providers, advertising companies and third parties have poured millions of dollars into possible solutions. Utilization of cookies (that track web habits on a user's own computer), utilization of content based on current actions (e.g., a search for restaurants may produce restaurant related advertisements in conjunction with search results), and many less refined approaches verging on the “shotgun” concepts, have all produced possible advertising paradigms that are currently used. While much work and effort has gone into cracking this elusive code, however, significant room for additional innovation remains.

### SUMMARY

In a first illustrative embodiment, a system includes a processor configured to receive a request from a website, including a unique identifier. The processor is also configured to receive information about one or more types of advertisements suitable for playback on the requesting website. Further, the processor is configured to identify a user record in a user database, based on the unique identifier. Additionally, the processor is configured to determine one or more advertisements that are likely to appeal to the user and are suitable for playback on the requesting website. The processor is also configured to provide an advertisement recommendation to the requesting website.

In a second illustrative embodiment, a computer-implemented method includes receiving a request from a website, including a unique identifier. The method also includes receiving information about one or more types of advertisements suitable for playback on the requesting website. Further, the method includes identifying a user record in a user database, based on the unique identifier. The method additionally includes determining one or more advertisements that are likely to appeal to the user and are suitable for playback on the requesting website. The method also includes providing an advertisement recommendation to the requesting website.

In a third illustrative embodiment, a non-transitory computer readable storage medium, stores instructions that, when executed by a processor, cause the processor to perform a method including receiving a request from a website, including a unique identifier. The method also includes receiving information about one or more types of advertisements suitable for playback on the requesting website. Further, the method includes identifying a user record in a user database, based on the unique identifier. The method additionally includes determining one or more advertisements that are likely to appeal to the user and are suitable for playback on the requesting website. The method also includes providing an advertisement recommendation to the requesting website

### BRIEF DESCRIPTION OF THE DRAWINGS

FIG. 1 shows an example of a database entry with exemplary elements for a given user;

FIG. 2 shows an illustrative process for tracking user behavior;

FIG. 3 shows an illustrative process for confirming user registration;

FIG. 4 shows an illustrative process for recording user behavior;

FIG. 5 shows an illustrative process for advertisement provision; and

FIG. 6 shows an illustrative process for accessing a user record and data flow between a site and a remote data storage location.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In many of the available free content mediums frequented by Internet users, challenges currently exist in determining appropriate advertising content for provision to the users. Because the sites themselves often are not “sellers” of any product in a traditional sense, they may have very little data on which to determine advertisement provision. In some instances, the sites may use past advertisements on which a user clicked to determine future advertisements to provide. This approach utilized alone, however, may not provide satisfactory results, as user clicks could be the result of a mis-click or relate to a whim of a user at a given time.

If these content providers could more accurately gauge the products actually purchased by users on the Internet, they could provide much more targeted advertising that has a high likelihood of success in encouraging user purchases. This will help drive advertising sales in general, and can also drive up revenues significantly, as the advertisers often pay some form of bounty on a click that also results in a purchase.

Among other things, the illustrative embodiments propose methods to gather such data from users across a variety of websites, in order that an advertiser can be provided with a much more accurate snapshot of a particular consumer and that person's spending habits. By pooling resources across a history of browsing and/or purchasing habits, information gathered from a plethora of websites can provide each of those websites (and others) with the ability to more effectively present a user with advertising content that may be of specific interest to the user.

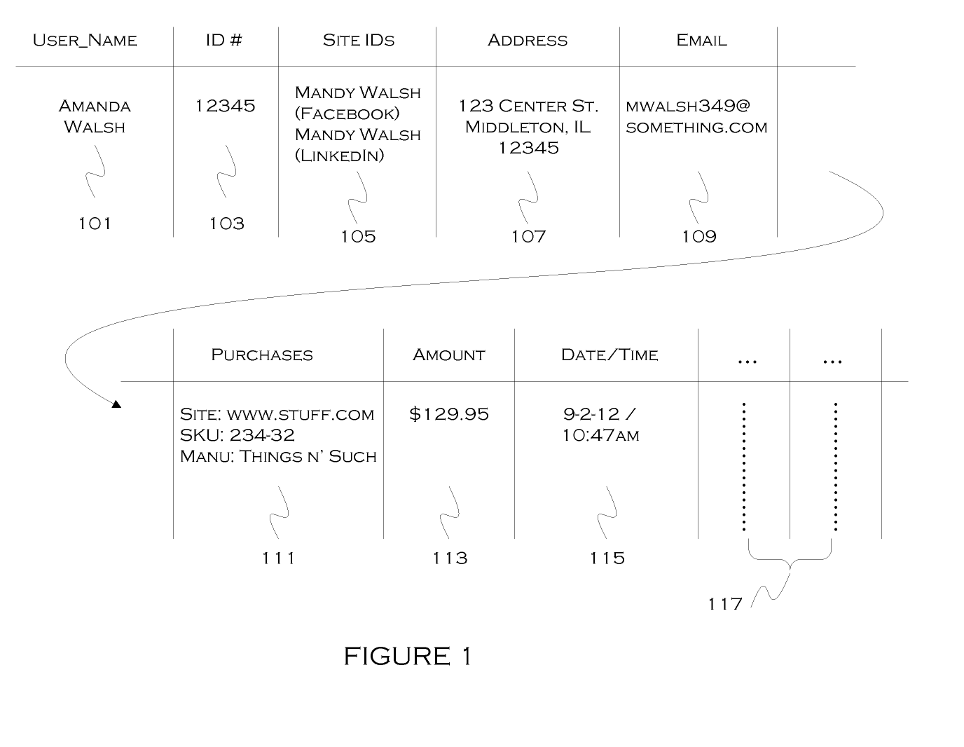

FIG. 1 shows an example of a database entry with exemplary elements for a given user. In this illustrative embodiment, showing possible, but non-limiting, data elements associated with a user, it can be seen how aggregation of various site affiliations and purchase behavior can provide a record usable in a variety of advertising paradigms.

In this example, a first data element references a user name 101. In this model, the name is the actual full name of the user, and can also be used as a semi-unique means to identify a user. Since many names are in common usage, a unique ID number 103 may also be associated with a user. Use of this number when passing and/or retrieving data to/from the database can ensure that accurate information is being transmitted and recorded.

Also, in this example, a variety of site IDs are recorded 105. These can, for example, correspond to specific user identities across a variety of websites (social media, shopping web sites, search engines, etc.). These can further help identify a user if a request for adding or retrieving data (or both) comes from a known website. For example, in this model, if a request came in from Facebook, it may identify the user, Amanda Walsh, as Mandy Walsh.

Additional categories, such as address 107, email 109, phone number, known shipping addresses, etc. may be used to further refine a search or used as stand-alone identifiers if appropriate (such as, for example, an email address, which is unique). At any given time, the database itself, since it may be assembled over time from observed/received information and behavior, may contain an incomplete record for a given party, but through the use of sufficient information a relatively accurate “guess” as to a specific user can be made, even if no specifically unique information is available.

For example, assume that Linked In has the following pieces of information associated with Amanda Walsh: full name—Amanda Walsh; address—123 Center St., Middletown, Ill., 12345; and email Amanda.Walsh@work.com. A request from Linked In to access the record may first include an attempt to search by email. Since there is no record of Amanda's work email, this attempt would fail, and then a more generalized search could be run on Amanda's name. If four Amanda Walsh's were found, the process could then search among those four based on physical address, and a match could be determined. It is, of course, possible to also search based on address initially, but if multiple people live at one address (or if Amanda has moved) this record could be similarly non-specific. A combination of data, however, will generally ensure that the proper record is being accessed.

The ID 103, could then be returned to Linked In and utilized with any session requests, or even stored with association to the Linked In account in order to facilitate future sessions.

Additionally, the database record may contain information about purchases (or other consumer-relevant web activity) associated with Amanda Walsh. For example, without limitation, a list of recent purchases 111 could be included. These could contain, but are not limited to, information about a site where a purchase was made, an item description, a SKU, a manufacturer, etc.

The database could also contain information about amounts that were spent 113 and dates and times of purchases. This and other data 117 could be relevant to tracking Amanda's spending habits and to providing guidelines as to what sorts of advertisements may be successfully targeted at Amanda. Over time, this record could become quite comprehensive and could provide detailed information including such elusive information as seasonal behavior, shopping tendencies around tax-return/year-end bonus time, and big, infrequent purchases (furniture, vehicles, etc.).

For example, advertisements directed at a new couch may generally be lost on Amanda, but if her recent records show that she has spent a great deal of time on furniture retail sites and has bought a number of items that would go into, for example, a living room, a furniture advertisement may be highly relevant and could generate a large windfall for the site providing the “winning” advertisement. In this manner, even highly isolated incidences of shopping behavior can be tracked and appropriately addressed by advertisements.

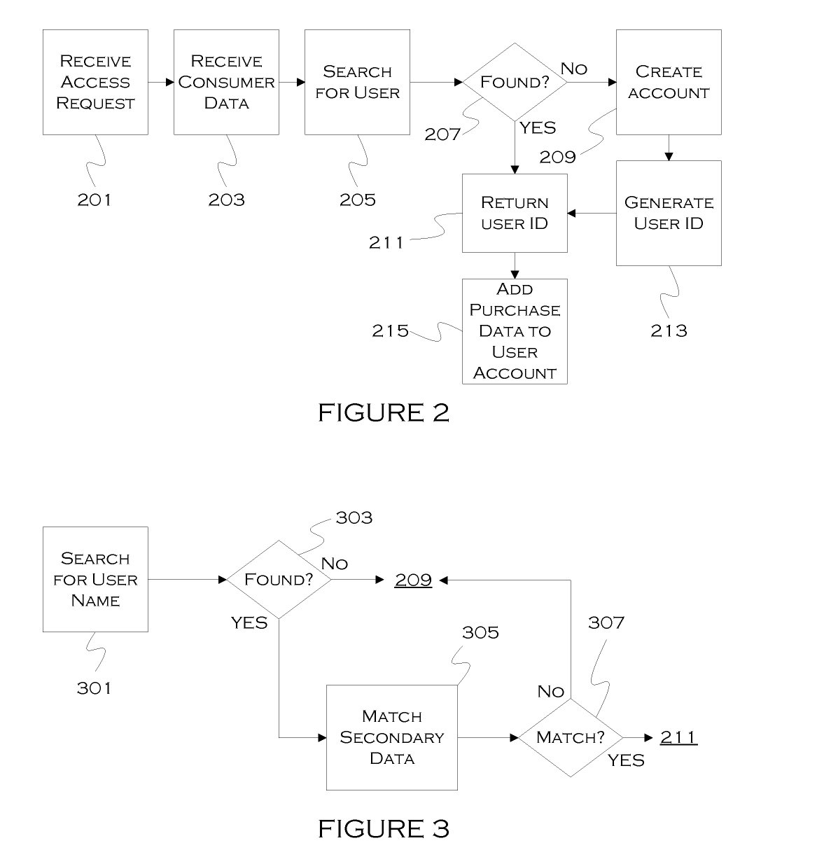

FIG. 2 shows an illustrative process for tracking user behavior. In this illustrative example, an intermediary site, providing database information on users and even possibly advertisements corresponding to observed user behavior, is accessed by a retailer or content provider in the interest of both providing purchasing data and/or receiving advertisement recommendations. Although an individual retailer might not necessarily want to provide this information (because it could aid competitors), the advantages provided by the comprehensive database should more than make up for the “cost” of sharing the data. By participating, the retailer can obtain information relating to numerous other purchases and, if the retailer is also an advertiser, the retailer can encourage delivery of additional advertisements to products specific to that retailer by providing evidence that a consumer shops at that retailer.

In the case of a non-retailer content provider the incentive is even greater to provide useful information, as it can be aggregated and used to ensure better delivery of appropriately selected advertisements. In this illustrative example, the intermediary (which could also simply be a database directly associated with any retailer/content provider, and isn't necessarily self-contained as a third party entity) receives a request to access a record 201. This request will typically, although not necessarily, be generated by a user (e.g., Amanda) logging into a retail or content-providing site.

The user's login can cause the site to send an access request to the database, both for purposes of tracking information and for purposes of obtaining recommendations. In conjunction with the access request, information relating to the specific consumer 203 may be received. If the originating site has a unique ID number already registered for the consumer, then that may be all the information that is needed to identify the consumer. If, however, the site does not have this information, either because it isn't stored at the site or because the access request is a new one for this user from the originating site, other user information (name, email, phone number, etc.) may be transmitted.

Any relevant information that is transmitted as part of the request may be used to search for the particular consumer in the database records 205. If the user is found 207, then there is likely at least a unique ID associated with that user, which can be passed back to the originating site 211 for use in the current session. Of course, user information not including an ID could always be utilized if desired, but in this example an ID will be utilized for unique identification purposes.

If the user is not found, then an account can be dynamically created using any and all consumer information passed to the remote site 209. By creating a new account, at least the passed information can be stored and activity tracking can begin. In this way, if a different originating site requests access to a user in the future, at least some information relating to that user can be obtained. Since the user does not have to enter information, in this example, as the data used to create the account is merely whatever the originating site is willing to provide, the user experience on the front end (i.e., at the originating website), is not interrupted.

During the generation of a new user account 209, in this illustrative embodiment, the process may also generate a new user ID to uniquely identify the new user 213. Once this ID has been generated, it can be passed along to the requesting site for use, as if the user had been otherwise found. Of course, there may be limited information available if the account has just been created, but at a minimum the ID can be utilized for tracking of ongoing activity.

As the consumer browses the site and make consumer-related decisions or purchases, the requesting site can report back to the database with the appropriate information. This information can be logged with a consumer record to provide a comprehensive model of consumer shopping.

FIG. 3 shows an illustrative example of a process for searching for a user. In this illustrative example, it is possible that a content providing website is using user-specific details known to that website to attempt to find a user.

As previously noted, there are several ways a user could be identified to the database. In a first example, the user could log in via a “portal” that the database provider delivers to the content providers. This portal could reside on the content provider website, and accessing it could log the consumer directly into the database. In this instance, since the database provider controls the login and maintains the user account, merely logging in may suffice to identify the user to the database (and provide the content provider with the requisite information).

In a second example, a user may log into a third party intermediary site, such as Facebook. In this case, Facebook will control the login and user account information, and will thus need to identify the user to the database. If this is a common method of accessing the database, in a case such as this, it may be the case that Facebook or another third party intermediary has worked out a deal with the database provider, such that an ID or other unique data is stored on Facebook allowing easy access of the database.

In the third instance, it may be the case that the content provider has its own login capability on the site. For example, if a magazine had a subscription login, then a user may naturally log in when visiting the site. In order to prevent the need for a second login, the magazine may wish to use this first login to identify the user to the database. Once a user has been identified once, the content provider can save a unique identifier, such as an ID, with respect to the user account, but on the first attempt to find user data or report user data, the content provider may not know the ID.

In such a case, the content provider may need an alternative method of finding the user. In this illustrative example, one non-limiting method is shown. Here, a search is done for a user name 301. This commonly will be the actual name of the user, but it could be a login ID or other information identifying a user. If the database contains a match this search will result in a hit 303, but there could be more than one user with the same name, or there could be a sole user currently registered to that name who is different that the party the site is trying to identify. In these instances, a secondary check can be done to ensure that the party is the correct party.

In this example, it is assumed that the requesting site has some form of additional information about a user. Whether an email address, physical address, phone number or other ID, cross referencing a second piece of data will typically ensure that the specific user found is the one for which information is requested (i.e., there may be many John Smiths, but there's probably only one living at a given address). The secondary information is also searched 305, and if it matches one of the records 307 then the system assumes that the correct user has been found.

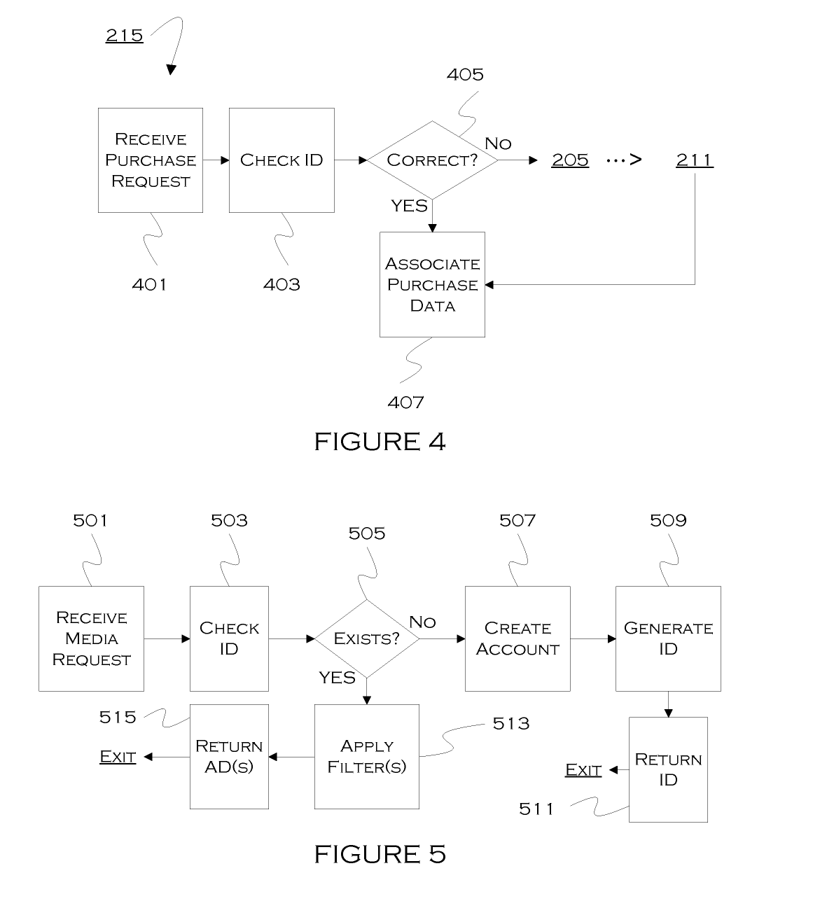

FIG. 4 shows an illustrative example of recording information in the remote database. In this illustrative example, a content provider registers that a user has made a purchase (or other consumer recordable event). In order to assist the intermediary database with the gathering and dissemination of information, the content provider will report such events to the database so the information can be added to the aggregate record.

In this illustrative example, the content provider sends a request to the database to register an event 401. Since the event is desired to be linked to a user account, the reporting may also include some other identifier. In one instance, the identifier could be a user ID associated with the database. in another instance, the information can be other known user information, such as that used in the description of FIG. 3.

Also, in this example, the database will then look up the identifying information to check for a match 403. If the information accurately identifies one of the records stored on the database 405, the process can confirm that the information should be recorded with respect to that record. The information, or a subset of the information, can be stored 407 to provide an ever improving record of user preferences.

In the event that the identifying information cannot be used to identify a user, the database assumes that the user does not exist in the database. While it may be the case that a particular website has insufficient information to identify an already existing user, the process described hereinafter will still provide at least a record of that user's behavior with respect to the particular requesting website.

In this example, if the process cannot identify a user, the process proceeds to create a new user account. The new user account will contain, in this example, an ID which can be provided to the website. Even if this account is a secondary account for an already existing user, the website will report activity thereon to this account, and with respect to that website, at least a record of user behavior can be recorded. Presumably, if, for example, a purchase is made and some form of unique information is eventually obtained by a website and provided to the database, the information may Identify the primary user account and the information can be merged.

FIG. 5 is an illustrative example of a process for providing a content provider with requested information. In this illustrative example, as well as reporting user behavior, a content provider can also request information from the database. The information can be used to determine particular advertisements for display, or, in another instance, the database itself can provide actual recommended advertisements.

In one instance, a content provider may be interested in obtaining advertisements most likely to spark purchasing behavior. If the content provider self-determines an advertisement for display, the content provider may not realize that such an advertisement has already been displayed to a user by another site and utilized. In other words, if the advertisement advertises an item that the user is only likely to purchase once, and that advertisement has already been utilized by a user, then displaying such an advertisement may actually be the last thing a content provider would like to do. By providing and tracking advertisements, the database can both ensure a portion of the revenue from utilized advertisements flows to the database provider while also tracking advertisement utilization to provide better selection of advertisements for the content provider.

In this illustrative example, a content provider requests media from the database 501. After the request has been received, the database will check an identifier associated with the request 503. As with the previous identifiers, the identifier can include a unique ID, a user name, or other information. If the identifier successfully identifies a known user 505, the database can then retrieve information relevant to the request.

In this example, the process may retrieve a database record, and then look at known consumer behavior along with advertisements that have been commonly utilized by the particular user. The process may also include the application of filters 513, based on known variables and/or information about the requesting site. For example, if a requesting site is a fashion magazine, it may have little interest in displaying an advertisement about a television, even if that is what the database would otherwise recommend. Instead, the filters will select the top advertisement that is scenario appropriate and deliver that advertisement for display. Of course, it's entirely possible that the magazine would simply like the advertisement with the highest likelihood of success, and in such a case the filters may be ignored. In other instances, the database may simply be built without filtering capability.

Once any desired filtering has been done to the information, an advertisement is returned 515. In an alternative scenario, a recommendation about a type of advertisement may be returned, if the content provider wishes to generate or select their own advertisement. In a third scenario, a plurality of information bits or advertisements may be returned from which the provider can select.

In at least one instance the database provider may have some intention of making money by delivery of advertisements. A number of monetization solutions are possible, including subscription based services, per use charged services, payment upon successful advertisement use, etc. Depending on the type of data delivered, certain solutions may be more optimal for maximizing profits.

In this example, as with the other searches, it is possible that the user does not yet exist in the database. Since some identifying information has been provided at step 503, the process has some information on which a new account can be created. In this example, the process creates a new account 507, and generates an ID. The ID is then delivered in response to the request. Unfortunately, in such a case, no information can be provided, but at least a user account now exists and user behavior can be tracked for later usage.

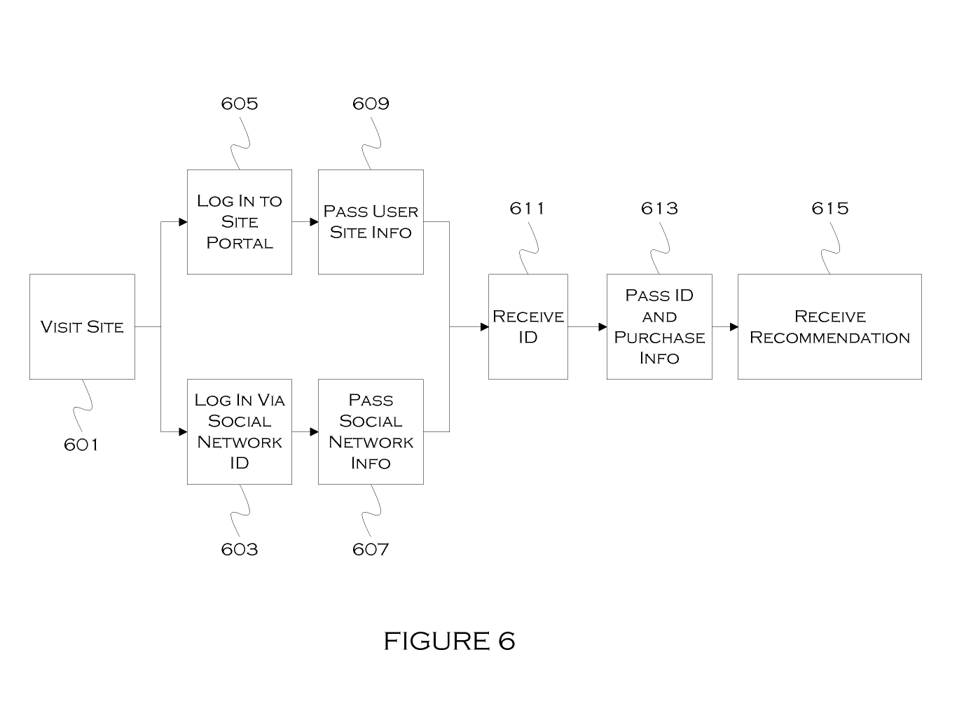

FIG. 6 shows an illustrative example of an exemplary process for retrieving information from a content provider's perspective. In this illustrative example, the process begins with a visit to a site from a user. Since the process is concerned with tracking individual behavior, in this example, there is no further action taken until a user provides some form of log in at the content provider site. This could be a login to a portal on the site (e.g., a site maintained portal) 605 or, in another example, a login to a third party portal such as Facebook 603.

In the login to the site portal, in this example, user account information stored by the site is passed to the remote database 609, and can be utilized for looking up user information. This process has already been described in the form of several non-limiting examples presented herein. In the example where a Facebook login occurs, information stored by the third party is used for user identification. This could be a user ID, or other user identifying information. It could even be the passing of the user login and password, if this is how users are tracked.

In response to the identification request, the remote database returns an identification that is utilized by the remote database to identify the user. This can then be stored at the remote site once received 611. The ID will help in identifying future requests or recordation of activity. In this example, the site, upon each request for information, or reporting of recordable activity, includes the user identification 613. This ensures that the remote database properly records the information with respect to the correct account.

In response to the request, the database sends back advertisements and/or information. Any such data is received by the content provider 615 and handled accordingly.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

We claim:

1. A system comprising:
a processor configured to:
receive a request from a website, including a unique identifier;
receive information about one or more types of advertisements suitable for playback on the requesting website;
identify a user record in a user database, based on the unique identifier;
determine one or more advertisements that are likely to appeal to the user and are suitable for playback on the requesting website; and
provide an advertisement recommendation to the requesting website.

2. The system of claim 1, wherein the unique identifier includes a user email address.

3. The system of claim 1, wherein the unique identifier includes a user name.

4. The system of claim 1, wherein the unique identifier includes a user ID number.

5. The system of claim 1, wherein the determination of one or more advertisements that are likely to appeal to the user is made based on observed and recorded user purchase behavior.

6. The system of claim 1, wherein provision of the recommendation includes provision of the actual advertisement media.

7. The system of claim 1, wherein the processor is further configured to:
receive information about user behavior within the requesting website;
analyze the received information to extract information relevant to user advertising preferences; and
update the user record to reflect the extracted information.

8. A computer-implemented method comprising:
receiving a request from a website, including a unique identifier;
receiving information about one or more types of advertisements suitable for playback on the requesting website;
identifying a user record in a user database, based on the unique identifier;
determining one or more advertisements that are likely to appeal to the user and are suitable for playback on the requesting website; and
providing an advertisement recommendation to the requesting website.

9. The method of claim 8, wherein the unique identifier includes a user email address.

10. The method of claim 8, wherein the unique identifier includes a user name.

11. The method of claim 8, wherein the unique identifier includes a user ID number.

12. The method of claim 8, wherein the determining one or more advertisements that are likely to appeal to the user is made based on observed and recorded user purchasing behavior.

13. The method of claim 8, wherein providing the recommendation includes providing the actual advertisement media.

14. The method of claim 8, further comprising:
receiving information about user behavior within the requesting website;
analyzing the received information to extract information relevant to user advertising preferences; and
updating the user record to reflect the extracted information.

15. A non-transitory computer readable storage medium, storing instructions that, when executed by a processor, cause the processor to perform a method comprising:
receiving a request from a website, including a unique identifier;
receiving information about one or more types of advertisements suitable for playback on the requesting website;
identifying a user record in a user database, based on the unique identifier;
determining one or more advertisements that are likely to appeal to the user and are suitable for playback on the requesting website; and
providing an advertisement recommendation to the requesting website.

16. The storage medium of claim 15, wherein the unique identifier includes a user email address.

17. The storage medium of claim 15, wherein the unique identifier includes a user name.

18. The storage medium of claim 15, wherein the unique identifier includes a user ID number.

19. The storage medium of claim 15, wherein the determining one or more advertisements that are likely to appeal to the user is made based on observed and recorded user purchasing behavior.

20. The storage medium of claim 15, wherein providing the recommendation includes providing the actual advertisement media.

21. The storage medium of claim 15, further comprising:
receiving information about user behavior within the requesting website;
analyzing the received information to extract information relevant to user advertising preferences; and
updating the user record to reflect the extracted information.
